(19) United States
(12) Patent Application Publication
(10) Pub. No.: US 2026/0331996 A1
(43) Pub. Date: Oct. 22, 2026

(54) ELECTRIC MOTOR COOLING COVER AND ELECTRIC MOTOR

(71) Applicant: INNOMOTICS GMBH, Nümberg (DE)

(72) Inventors: Lun Wang, Liaoning (CN); YAN WEI SONG, Tianjin (CN); KE XIN WANG, Tianjing (CN); JUN LI ZHU, Shaanxi (CN)

(73) Assignee: INNOMOTICS GMBH, Nümberg (DE)

(21) Appl. No.: 19/483,815

(22) PCT Filed: May 14, 2024
(86) PCT No.: PCT/EP2024/063131

§ 371 Date: Nov. 12, 2025

(30) Foreign Application Priority Data
May 16, 2023 (CN) 202321183592.6

(51) Int. Cl. H02K 5/20; H02K 9/26

(52) U.S. Cl. CPC H02K 5/207; H02K 9/26

(57) ABSTRACT

A cooling cover includes a base plate for installation on a body of an electric motor, a cover plate, an enclosure connected between the base plate and the cover plate and two partitions. The enclosure, the base plate and the cover plate form an air compartment. The partitions are located in the air compartment and separate the air compartment into first and second air inlet chambers and an air outlet chamber which is formed between the two partitions. The base plate has at least two first air inlets in the first air inlet chamber, at least two second air inlets in the second air inlet chamber, and an inner air outlet in the air outlet chamber. The enclosure has a third air inlet in the first air inlet chamber, a fourth air inlet in the second air inlet chamber, and an outer air outlet in the air outlet chamber.

### TECHNICAL FIELD

The present application relates to the technical field of mechanical equipment, and in particular to an electric motor cooling cover and an electric motor.

### BACKGROUND ART

Large electric motors generate great amounts of heat, so they have very high heat dissipation requirements. An electric motor is usually equipped with a cooling cover to quickly dissipate internal heat, thereby preventing heat accumulation that may cause failure.

The cooling cover has an air inlet and an air outlet, and the electric motor is provided with openings corresponding to the air inlet and the air outlet. External cold air enters the cooling cover through the air inlet, then enters the interior of the electric motor, and then is discharged from the cooling cover through the air outlet. Heat inside the electric motor is taken away in this process.

However, a cooling cover in the prior art has a complex structure and is large.

### SUMMARY OF THE UTILITY MODEL

To solve the above technical problems, embodiments of the present application provide an electric motor cooling cover and an electric motor. The electric motor cooling cover makes it possible to solve the above technical problems.

In a first aspect, the present application provides an electric motor cooling cover for installation on the body of the electric motor, the cover comprising a base plate, a cover plate, an enclosure and two partitions, the base plate being configured to be installed on the body, the enclosure being connected between the base plate and the cover plate, the enclosure, the base plate and the cover plate forming an air compartment; the two partitions are located in the air compartment and are spaced apart to separate the air compartment into mutually independent air outlet chambers, a first air inlet chamber and a second air inlet chamber, the air outlet chamber being formed between the two partitions, the air outlet chamber being located between the first air inlet chamber and the second air inlet chamber; the base plate is provided with at least two first air inlets located in the first air inlet chamber, at least two second air inlets located in the second air inlet chamber, and an inner air outlet located in the air outlet chamber; the enclosure is provided with a third air inlet located in the first air inlet chamber, a fourth air inlet located in the second air inlet chamber, and an outer air outlet located in the air outlet chamber; the base plate extends along a first direction and has opposite first and second ends in the first direction, wherein at least one first air inlet and at least one second air inlet are located at the first end and are configured to communicate with a first cooling inlet of the body, and at least one first air inlet and at least one second air inlet are located at the second end and are configured to communicate with a second cooling inlet of the body.

Optionally, the number of first air inlets is two, the number of second air inlets is two, the base plate comprises a first isolation area located between two first air inlets, the base plate comprises a second isolation area located between the two second air inlets, the third air inlet is aligned with the first isolation area, and the fourth air inlet is aligned with the second isolation area.

Optionally, the first isolation area has a first orthographic projection on the enclosure, both ends of the first orthographic projection being spaced by the same distance from the third air inlet in the first direction; and/or, the second isolation area has a second orthographic projection on the enclosure, both ends of the second orthographic projection being spaced by the same distance from the fourth air inlet in the first direction.

Optionally, the inner air outlet is aligned with the first isolation area, and the length of the inner air outlet in the first direction is smaller than or equal to the length of the first isolation area in the first direction; and/or, the inner air outlet is aligned with the second isolation area, and the length of the inner air outlet in the first direction is smaller than or equal to the lengths of two second isolation areas in the first direction.

Optionally, the two partitions extend along the first direction, and the width of the outer air outlet is equal to the distance between the two partitions.

Optionally, the base plate comprises a slope provided in the air outlet chamber, the slope being located between the inner air outlet and the outer air outlet, the distance between the slope and the cover plate gradually decreasing in the direction toward the inner air outlet.

Optionally, the number of outer air outlets is two, the two outer air outlets being located on opposite sides of the inner air outlet, and the number of slopes is two, of which one is located between the inner air outlet and the outer air outlet and the other is located between the inner air outlet and the other outer air outlet.

Optionally, the cooling cover further comprises a first filter screen installed at the third air inlet, a second filter screen installed at the fourth air inlet, and a third filter screen installed at the outer air outlet.

Optionally, the cooling cover further comprises a plurality of ear plates connected to the base plate or the outer surface of the enclosure, the ear plates being configured to connect the body of the electric motor.

In a second aspect, the present application provides an electric motor comprising a body and an electric motor cooling cover as claimed in any one of claims 1-9 above, the body being provided with a first cooling inlet, a cooling outlet and a second cooling inlet that are spaced apart along the first direction, the first cooling inlet being in communication with one first air inlet and one second cooling inlet simultaneously, the second cooling inlet being in communication with the other first air inlet and the other second air inlet simultaneously, the cooling outlet being in communication with the inner air outlet.

An electric motor cooling cover provided by the present application allows a reduction of the height of the electric motor cooling cover, so that the height of the electric motor may be reduced; moreover, it is beneficial to efficiently carrying away heat in the electric motor body with external cold air, so that the electric motor has better heat dissipation capabilities.

### BRIEF DESCRIPTION OF THE DRAWINGS

FIG. 1 is a schematic perspective view of a cooling cover provided by an embodiment of the present application, in which the cover plate is omitted;

FIG. 2 is a schematic cross-sectional view of an electric motor provided by an embodiment of the present application;

FIG. 3 is a schematic diagram of a cooling cover;

FIG. 4 is a schematic perspective view of the cooling cover in FIG. 3, in which part of the structure is omitted.

### REFERENCE NUMERALS USED IN THE DRAWINGS

10—base plate
11—first air inlet
12—second air inlet
13—inner air outlet
14—slope
20—enclosure
21—third air inlet
22—fourth air inlet
23—outer air outlet,
30—partition
40—ear plate
50—body (50)
51—first cooling inlet
52—second cooling inlet
53—cooling outlet.

### SPECIFIC EMBODIMENTS

To make clearer the objectives, technical solutions, and benefits of the present application, a more detailed description of embodiments of the present application will be provided below in conjunction with the attached drawings.

It should be noted that in the description of the present application, orientations or positional relationships indicated by terms such as “central”, “upper”, “lower”, “front”, “rear”, “left”, “right”, “vertical”, “horizontal”, “top”, “bottom”, “inner”, and “outer” are usually based on the orientations or positional relationships shown in the drawings, are only intended for convenience of describing the present application and brevity of description, rather than indicating or implying that the device or element referred to must have a specific orientation or be constructed and operated in a specific orientation, and therefore should not be understood as a limitation of the protection scope of the present application.

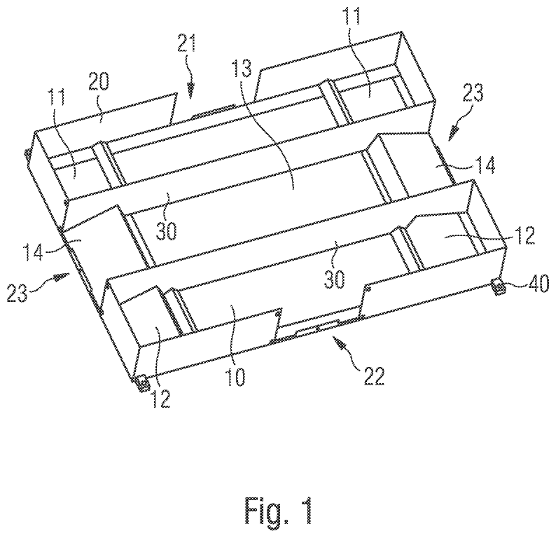

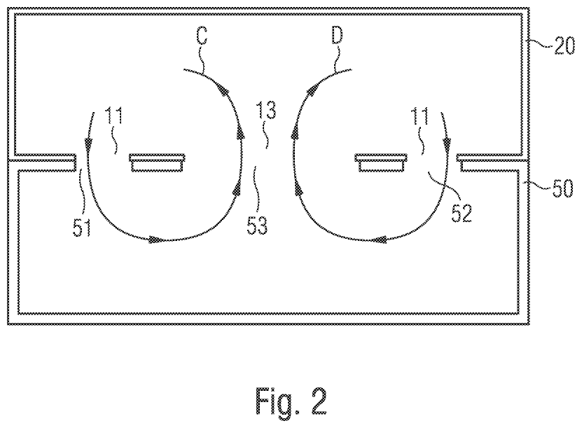

The present application provides an electric motor cooling cover, as shown in FIG. 1 and FIG. 2, for installation on the electric motor body 50, the cooling cover comprising a base plate 10, a cover plate, an enclosure 20, and two partitions 30, the base plate 10 being configured to be installed on the body 50, the enclosure 20 being connected between the base plate 10 and the cover plate, the enclosure 20, the base plate 10 and the cover plate forming an air compartment; the two partitions 30 are located in the air compartment and distributed at intervals to separate the air compartment into mutually independent air outlet chambers, a first air inlet chamber and a second air inlet chamber, the air outlet chamber being formed between the two partition plates 30, the air outlet chamber being located between the first air inlet chamber and the second air inlet chamber; the base plate 10 is provided with at least two first air inlets 11 located in the first air inlet chamber, at least two second air inlets 12 located in the second air inlet chamber, and an inner air outlet 13 located in the air outlet chamber; the enclosure 20 is provided with a third air inlet 21 located in the first air inlet chamber, a fourth air inlet 22 located in the second air inlet chamber, and an outer air outlet 23 located in the air outlet chamber; the base plate 10 extends along a first direction and has opposite first and second ends in the first direction, at least one first air inlet 11 and at least one second air inlet 12 are located at the first end and are configured to communicate with the first cooling inlet 51 of the body 50, at least one first air inlet 11 and at least one second air inlet 12 are located at the second end and are configured to communicate with the second cooling inlet 52 of the body 50. No cover plate is shown in FIG. 1.

In other words, the two partitions 30 are hermetically connected to the base plate 10, the cover plate and the enclosure 20 on all sides, respectively, to divide the air compartment into mutually independent air outlet chambers, a first air inlet chamber and a second inlet chamber, so that the three air chambers are do not communicate with each other inside the air compartment.

When the above technical solution is adopted, after the cooling cover is installed on the electric motor body 50, external cold air may enter the first air inlet chamber through the third air inlet 21 and then be divided into at least two streams of cold air, which pass through at least two first air inlets 11 of the base plate 10, respectively, to enter the interior of the electric motor body 50, then are discharged from the interior of the electric motor body 50 through the cooling outlet 53 on the body 50, enter the air outlet chambers through the inner air outlet 13 on the base plate 10, and finally are discharged from the air outlet chambers of the outer air outlet 23, that is, being discharged from the air compartment. Similarly, external cold air may enter the second air inlet chamber through the fourth air inlet 22, and then be divided into at least two streams of cold air, which respectively enter the interior of the electric motor body 50 through at least two second air inlets 12 on the base plate 10, then are discharged from the inside of the electric motor body 50, enter the air outlet chambers through the inner air outlet 13 on the base plate 10, and finally are discharged from the air outlet chambers through the outer air outlet 23, that is, being discharged from the air compartment. In other words, external cold air may enter the first cooling inlet 51 on the electric motor body 50 through at least one first air inlet 11 and at least one second air inlet 12 at the first end, and may also pass through the second cooling inlet 52 on the electric motor body 50 through at least one first air inlet 11 and at least one second air inlet 12 at the second end. Refer to the flow paths C and D of the cold air in the electric motor in FIG. 2.

In one aspect, at least two first air inlets 11 and at least two second air inlets 12 are distributed around the inner air outlet 13. External cold air may enter the first cooling inlet 51 of the electric motor body 50 through at least one first air inlet 11 and at least one second air inlet 12 at the first end, while entering the second cooling inlet 52 of the electric motor body 50 through at least one first air inlet 11 and at least one second air inlet 12 at the second end, before being discharged from the inner air outlet 13 located in the middle. Obviously, the flow path of each stream of cold air entering the electric motor body 50 in the electric motor body 50 is approximately half of the distance between the first cooling inlet 51 and the second cooling inlet 52, which keeps the temperature difference between each stream of cold air and the flow path within a wide range, so that the heat in the electric motor body may be taken away more efficiently to improve the cooling effect.

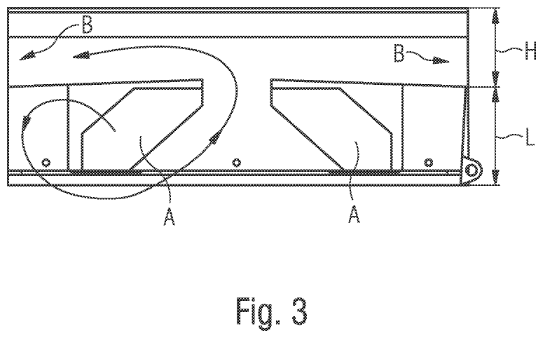

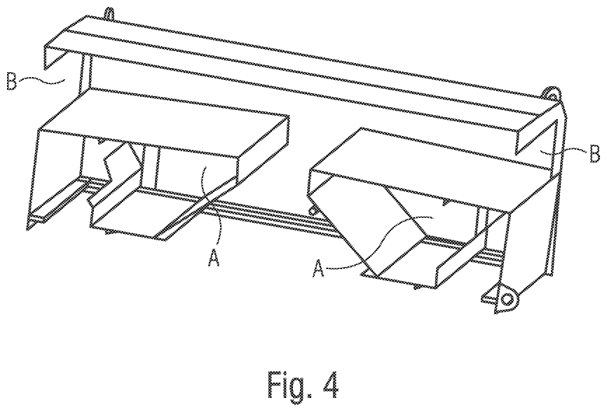

In another aspect, FIG. 3 and FIG. 4 are respectively schematic diagrams of a cooling cover from different perspectives. The air inlet A is on the side, and the air outlet B faces both ends, with external cold air flowing from the air inlet A to the air outlet B in the direction indicated by the arrow. The air inlet A and the air outlet B are distributed along the up-down direction indicated in the figure. In this structure, a height H must be reserved for arranging the air outlet B, and a height L must be reserved for arranging the air inlet A, which is structurally complex and increases the height of the cooling cover, resulting in high costs in cooling cover material and processing. In an electric motor cooling cover provided by the present application, the third air inlet 21, the fourth air inlet 22 and the outer air outlet 23 are all located on the enclosure 20. In the height direction of the distribution of the cover plate and the base plate 10, the heights of these three air ports relative to the base plate 10 may be the same or different, depending on the locations of and size requirements for these three air ports, so that the cooling cover can have a small height. Therefore, compared with the cooling cover shown in FIG. 2 and FIG. 3, an electric motor cooling cover provided by the present application has a simple structure, a small height, and a small overall size, allowing a reduction of the amount of material used.

In a possible embodiment, the number of first air inlets 11 is two, the number of second air inlets 12 is two, the base plate comprises a first isolation area located between the two first air inlets 11, the base plate comprises a second isolation area located between the two second air inlets 12, the third air inlet 21 is aligned with the first isolation area, and the fourth air inlet 22 is aligned with the second isolation area. Thus, cold air entering the first air inlet chamber from the third air inlet 21 may be divided into two streams of cold air, which flow to the first end and the second end of the base plate 10 respectively, thereby entering the first cooling inlet 51 of the electric motor body 50 through a first air inlet 11 and entering the second cooling inlet 52 of the electric motor body 50 through the other first air inlet 11; similarly, cold air entering the second air inlet chamber from the fourth air inlet 22 may be divided into two streams of cold air, which flow to the first end and the second end of the base plate 10 respectively, thereby entering the first cooling inlet 51 of the electric motor body 50 through a second air inlet 12 and entering the second cooling inlet 52 of the electric motor body 50 through the other second air inlet 12. Since the third air inlet 21 is aligned with the first isolation area, foreign bodies, water vapor, etc., that enter the first air inlet chamber with cold air may be intercepted by the first isolation area, so that foreign bodies and water vapor are reduced or stopped from entering the electric motor body 50 through the first air outlet 11. Similarly, since the fourth air inlet 22 is aligned with the second isolation area, foreign bodies, water vapor, etc., that enter the second air inlet chamber with cold air may be intercepted by the second isolation area, so that foreign bodies and water vapor are reduced or stopped from entering the electric motor body 50 through the second air outlet 12. It should be noted that the third air inlet 21 being aligned with the first isolation area means that an orthographic projection of the third air inlet 21 on the base plate 10 is located in the first isolation area. The fourth air inlet 22 being aligned with the second isolation area means that an orthographic projection of the fourth air inlet 22 on the base plate 10 is located in the second isolation area.

In a possible embodiment, the first isolation area has a first orthographic projection on the enclosure 20, and both ends of the first orthographic projection are spaced apart from the third air inlet 21 by the same distance in the first direction. Thus, external cold air coming in through the third air inlet 21 may be evenly divided into two parts, which enter the electric motor body 50 through two first air inlets 11, respectively, which is beneficial to evenly cooling the opposite ends of the electric motor body 50. The distance between the two ends of the first front projection and the third air inlet 21 in the first direction may be designed according to the protection level required for the electric motor, which is not limited in the present application.

Similarly, the second isolation area has a second orthographic projection on the enclosure 20, and both ends of the second orthographic projection are spaced apart from the fourth air inlet 22 by the same distance in the first direction. Thus, external cold air coming in through the fourth air inlet 22 may be evenly divided into two parts, which enter the electric motor body 50 through two second air inlets 12, respectively, which is beneficial to evenly cooling the opposite ends of the electric motor body 50. The distance between the two ends of the second orthographic projection and the fourth air inlet 22 in the first direction may be designed according to the protection level required for the electric motor, which is not limited in the present application.

In a possible embodiment, the inner air outlet 13 is aligned with the first isolation area, and the length of the inner air outlet 13 in the first direction is smaller than or equal to the length of the first isolation area in the first direction. Thus, the cold air, after entering the electric motor body 50 from the first air inlet 11, is forced to fully travel in the electric motor body 50 and moves to the inner air outlet 13 of the cooling cover before entering the air outlet chamber through the inner air outlet 13, which ensures the cooling effect of cold air on the electric motor.

Similarly, the inner air outlet 13 is aligned with the second isolation area, and the length of the inner air outlet 13 in the first direction is smaller than or equal to the length of the second isolation area in the first direction. Thus, the cold air, after entering the electric motor body 50 from the second air inlet 12, is forced to fully travel in the electric motor body 50 and moves to the inner air outlet 13 of the cooling cover before entering the air outlet chambers through the inner air outlet 13, which ensures the cooling effect of cold air on the electric motor.

To sum up, it is clear that four air inlets surround one inner air outlet 13, and, after four streams of cold air enter the electric motor body 50 from four different positions of the electric motor body 50, they all move toward the middle position of the electric motor body 50, and may then be discharged from the inner air outlet 13 of the cooling cover, thereby forming an X-shaped cooling path in the electric motor, which can fully cool all parts of the electric motor to improve the cooling effect on the electric motor.

In a possible embodiment, the distance between the intersections of the two partitions 30 and the enclosure 20 is equal to the width of the outer air outlet 23. Thus, the outer air outlet 23 may be made to have a large size, so that cold air carrying heat flowing from the electric motor may be smoothly and quickly discharged to the external environment. The two partitions 30 can both extend along the first direction, which means that the two partitions 30 are parallel to each other, so that the width of the outer air outlet 23 may be equal to the distance between the two partitions 30.

In one example, the number of outer air outlets 23 is two, and the two outer air outlets 23 are symmetrically distributed on opposite sides of the inner air outlet 13. The two outer air outlets 23 have the same diameter and the same draught capacity, allowing cold air carrying heat flowing from the electric motor to be smoothly and quickly discharged to the external environment.

In a possible implementation, the base plate 10 comprises a slope 14 provided in the air outlet chamber, the slope 14 being located between the inner air outlet 13 and the outer air outlet 23, the distance between the slope 14 and the cover plate gradually decreasing in the direction toward the inner air outlet 13. Thus, the slope 14 can block external foreign bodies and water vapor, making it more difficult for foreign bodies and water vapor to enter the electric motor body 50 through the inner air outlet 13.

In one example, the number of outer air outlets 23 is two, the two outer air outlets 23 being located on opposite sides of the inner air outlet 13, and the number of slopes 14 is two, of which one is located between the inner air outlet 13 and one outer air outlet 23 and the other one is located between the inner air outlet 13 and the other outer air outlet 23.

In a possible implementation, the cooling cover further comprises a first filter screen installed at the third air inlet 21 and a second filter screen installed at the fourth air inlet 22. The first filter screen may be used to prevent an arm or another foreign body from entering the cooling cover from the third air inlet 21, and the second filter screen may be used to prevent an arm or another foreign body from entering the cooling cover from the fourth air inlet 22, which ensures safe electric motor operation and personnel safety.

In a possible implementation, the cooling cover further comprises a third filter screen installed at the outer air outlet 23. The third filter screen can prevent an arm or another foreign body from entering the cooling cover from the outer air inlet, ensuring safe motor operation and personnel safety.

The cooling cover may be fixed on the electric motor body 50 in various manners, for example, being fixed on the electric motor body 50 by bolts, pins, bonding, etc.

In one example, the cooling cover further comprises a plurality of ear plates 40 connected to the base plate 10 or the outer surface of the enclosure, the ear plates 40 being used to connect the electric motor body 50. Thus, the cooling cover may be conveniently and firmly fixed on the electric motor body 50.

The base plate 10, the cover plate, and the enclosure 20 may be spliced together by welding, pin connection, bonding, etc., and the partition 30 may be installed in the air compartment by welding, pin connection, bonding, etc. The cooling cover may be made of metal materials, such as steel plates and aluminum plates.

In a second aspect, the present application further provides an electric motor, which, as shown in FIG. 2, comprises a body 50 and a motor cooling cover as described above, the body 50 being provided with a first cooling inlet 51, a cooling outlet 53 and a second cooling inlet 52 that are spaced apart along a first direction, the first cooling inlet 51 being in communication with one first air inlet 11 and one second air inlet 12 simultaneously, the second cooling inlet 52 being in communication with the other first air inlet 11 and the other second air inlet 12 simultaneously, the cooling outlet 53 being in communication with the inner air outlet 13. Thus, based on the beneficial effects of the cooling cover described above, an electric motor provided by the present application has a small overall height and can have good heat dissipation capabilities.

It should be pointed out that according to implementation needs, a component/step of an embodiment of the present utility model may be divided into more components/steps, or two or more components/steps or some operations of a component/step may be combined into a new component/step to achieve the objectives of embodiments of the present utility model.

The above embodiments are only intended to illustrate embodiments of the present utility model, rather than being intended to limit embodiments of the present utility model. Those of ordinary skill in the art may make various changes and modifications to the embodiments without departing from the spirit and scope of the embodiments of the present utility model. Therefore, all equivalent technical solutions also fall within the scope of embodiments of the present utility model, and the scope of patent protection of embodiments of the present utility model should be defined by the claims.

1.-10. (canceled)

11. An electric motor cooling cover for installation on a body of an electric motor, the cooling cover comprising:
a base plate configured to be installed on the body;
a cover plate;
an enclosure connected between the base plate and the cover plate and designed to form with the base plate and the cover plate an air compartment; and
two partitions located in the air compartment and distributed at intervals to separate the air compartment into mutually independent first air inlet chamber, second air inlet chamber and an air outlet chamber, said air outlet chamber being formed between the two partitions and located between the first air inlet chamber and the second air inlet chamber,
wherein the base plate comprises at least two first air inlets located in the first air inlet chamber, at least two second air inlets located in the second air inlet chamber, and an inner air outlet located in the air outlet chamber, said base plate extending along a first direction and having opposite first and second ends in the first direction, with at least one of the at least two first air inlets and at least one of the at least second air inlets being located at the first end and configured to communicate with a first cooling inlet of the body, and with at least one of the at least two first air inlets and at least one of the at least two second air inlets being located at the second end and configured to communicate with a second cooling inlet of the body, and
wherein the enclosure comprises a third air inlet located in the first air inlet chamber, a fourth air inlet located in the second air inlet chamber, and an outer air outlet located in the air outlet chamber.

12. The electric motor cooling cover of claim 11, wherein a number of the first air inlets is two, and a number of the second air inlets is two, said base plate comprising a first isolation area located between the two first air inlets and a second isolation area located between the two second air inlets, with the third air inlet being aligned with the first isolation area, and the fourth air inlet being aligned with the second isolation area.

13. The electric motor cooling cover of claim 12, wherein the first isolation area includes on the enclosure a first orthographic projection which has two ends spaced by a same distance from the third air inlet in the first direction, and/or,
wherein the second isolation area includes on the enclosure a second orthographic projection which has two ends spaced by a same distance from the fourth air inlet in the first direction.

14. The electric motor cooling cover of claim 12, wherein the inner air outlet is aligned with the first isolation area and has in the first direction a length which is smaller than or equal to a length of the first isolation area in the first direction; and/or,
wherein the inner air outlet is aligned with the second isolation area and has in the first direction a length which is smaller than or equal to lengths of two of said second isolation area in the first direction.

15. The electric motor cooling cover of claim 11, wherein the two partitions extend along the first direction, said outer air outlet having a width which is equal to a distance between the two partitions.

16. The electric motor cooling cover of claim 11, wherein the base plate comprises a slope provided in the air outlet chamber and located between the inner air outlet and the outer air outlet, said slope having from the cover plate a distance which gradually decreases in a direction toward the inner air outlet.

17. The electric motor cooling cover of claim 16, wherein a number of outer air outlets is two, said two outer air outlets located on opposite sides of the inner air outlet, and wherein a number of slopes is two, with one of the slopes located between the inner air outlet and the outer air outlet and another one of the slopes located between the inner air outlet and the other outer air outlet.

18. The electric motor cooling cover of claim 11, further comprising:
a first filter screen installed at the third air inlet;
a second filter screen Installed at the fourth air inlet; and
a third filter screen installed at the outer air outlet.

19. The electric motor cooling cover of claim 11, further comprising a plurality of ear plates connected to the base plate or an outer surface of the enclosure, with the plurality of ear plates being configured to connect the body of the electric motor.

20. An electric motor, comprising:
body; and
the electric motor cooling cover of claim 11,
wherein the body comprises a first cooling inlet, a cooling outlet and a second cooling inlet that are spaced apart along the first direction, with the first cooling inlet communicating with one of the at least two first air inlets and one of the at least two second cooling inlets simultaneously, with the second cooling inlet communicating with another one of the at least two first air inlets and another one of the at least two second air inlets simultaneously, and with the cooling outlet communicating with the inner air outlet.

21. The electric motor of claim 20, wherein a number of the first air inlets is two, and a number of the second air inlets is two, said base plate comprising a first isolation area located between the two first air inlets and a second isolation area located between the two second air inlets, with the third air inlet being aligned with the first isolation area, and the fourth air inlet being aligned with the second isolation area.

22. The electric motor of claim 21, wherein the first isolation area includes on the enclosure a first orthographic projection which has two ends spaced by a same distance from the third air inlet in the first direction, and/or,
wherein the second isolation area includes on the enclosure a second orthographic projection which has two ends spaced by a same distance from the fourth air inlet In the first direction.

23. The electric motor of claim 21, wherein the inner air outlet is aligned with the first isolation area and has in the first direction a length which is smaller than or equal to a length of the first isolation area in the first direction; and/or,
wherein the inner air outlet is aligned with the second isolation area and has in the first direction a length which is smaller than or equal to lengths of two of said second isolation area in the first direction.

24. The electric motor of claim 20, wherein the two partitions extend along the first direction, said outer air outlet having a width which is equal to a distance between the two partitions.

25. The electric motor of claim 20, wherein the base plate comprises a slope provided in the air outlet chamber and located between the inner air outlet and the outer air outlet, said slope having from the cover plate a distance which gradually decreases in a direction toward the inner air outlet.

26. The electric motor of claim 25, wherein a number of outer air outlets is two, said two outer air outlets located on opposite sides of the inner air outlet, and wherein a number of slopes is two, with one of the slopes located between the inner air outlet and the outer air outlet and another one of the slopes located between the inner air outlet and the other outer air outlet.

27. The electric motor of claim 20, wherein the electric motor cooling cover comprises a first filter screen Installed at the third air inlet, a second filter screen Installed at the fourth air inlet, and a third filter screen installed at the outer air outlet.

28. The electric motor of claim 20, wherein the electric motor cooling cover comprises a plurality of ear plates connected to the base plate or an outer surface of the enclosure, with the plurality of ear plates being configured to connect the body of the electric motor.
